(19) United States
(12) Patent Application Publication
(10) Pub. No.: US 2020/0225257 A1
(43) Pub. Date: Jul. 16, 2020

(54) SAMPLE ANALYZER AND MIXING METHOD

(71) Applicant: SHENZHEN MINDRAY BIO-MEDICAL ELECTRONICS CO., LTD., Shenzhen (CN)

(72) Inventors: Qiushi YI, Shenzhen (CN); Zixian XIE, Shenzhen (CN); Yong DAI, Shenzhen (CN)

(73) Assignee: SHENZHEN MINDRAY BIO-MEDICAL ELECTRONICS CO., LTD., Shenzhen (CN)

(21) Appl. No.: 16/727,810

(22) Filed: Dec. 26, 2019

Related U.S. Application Data
(63) Continuation of application No. PCT/CN2017/091096, filed on Jun. 30, 2017.

(51) Int. Cl. G01N 35/10; G01N 1/38

(52) U.S. Cl. CPC G01N 35/1016; G01N 1/38; G01N 35/1002

(57) ABSTRACT

A sample analyzer, comprising a reaction assembly and a detection assembly, wherein the reaction assembly comprises a sampler and a reaction tank, the sampler is used for collecting a biological sample and injecting the biological sample into the reaction tank, a wall of the reaction tank is provided with a first through-hole used for injecting a first reagent, and a center line of the first through-hole is arranged to be misaligned with the sampler after the sampler moves into the reaction tank, the detection assembly is connected to the reaction tank and is used for drawing fluid from the reaction tank for test. The reaction assembly enables a solution to be more uniformly mixed.

### CROSS-REFERENCE TO RELATED APPLICATIONS

This application is a continuation of Patent Cooperation Treaty Application No. PCT/CN2017/091096, filed on Jun. 30, 2.017, the content thereof is hereby incorporated by reference in its entirety.

### TECHNICAL FIELD

The invention relates to the technical field of medical instruments, in particular to a sample analyzer and a mixing method.

### BACKGROUND

With the popularization of the application of blood cell analyzers, the accuracy requirement for test results of the blood cell analyzers is becoming higher and higher. After a blood sample is collected by a blood cell analyzer, the blood sample is mixed and reacts with a reagent in a reactor assembly, and the mixing degree (mixing uniformity) of the blood sample and the reagent directly affects the reaction effect of the blood sample and the reagent.

In the prior art, the following mixing approach is used: a sampling needle moves into a reaction tank containing a reagent and is immersed in the reagent to dispense a blood sample, and then the blood sample and the reagent are mixed by bubbling. The mixing degree of the above-mentioned mixing approach depends on the amount of bubbles, and the mixing effect is not good, resulting in poor reaction effect between blood samples and reagents, which makes the blood cell analyzer unable to provide accurate test results.

### SUMMARY OF THE INVENTION

The technical problem to be solved by the present application is to provide a reaction assembly having higher mixing degree, a sample analyzer and a mixing method.

In order to achieve the above purpose, an embodiment of the present application adopts the following technical solutions:

In one aspect, there is provided a sample analyzer, comprising a reaction assembly and a detection assembly, wherein the reaction assembly comprises a sampler and a reaction tank, the sampler is used for collecting a biological sample and injecting the biological sample into the reaction tank, a wall of the reaction tank is provided with a first through-hole used for injecting a first reagent, and a center line of the first through-hole is arranged to be misaligned with the sampler after the sampler moves into the reaction tank, the detection assembly is connected to the reaction tank and is used for drawing fluid from the reaction tank for test.

In some embodiments, the reaction tank is provided with an opening, and the sampler extends into the reaction tank through the opening.

In some embodiments, the center line of the first through-hole and a center line of the reaction tank are arranged in different planes.

In some embodiments, the wall comprises a first part with two open ends and a second part connected to one of the open ends, the first part is columnar and the second part is cambered.

In some embodiments, the first through-hole is arranged at a junction of the first part and the second part.

In some embodiments, an inner side of the wall comprises a first wall surface and a second wall surface connected to the first wall surface. The first wall surface comprises a first flat surface, a second flat surface, a first cambered surface and a second cambered surface; the first flat surface and the second flat surface are arranged opposite each other. The first cambered surface and the second cambered surface are arranged opposite each other and connected between the first flat surface and the second flat surface. The second wall surface comprises a first end connected to the first wall surface and a second end away from the first wall surface. The second wall surface tapers in a direction from the first end to the second end.

In some embodiments, the first through-hole extends through the second wall surface or a junction of the first wall surface and the second wall surface.

In some embodiments, the sample analyzer further comprises a first fluid dosing device, which is in communication with the sampler and is used to control the volume of the biological sample discharged by the sampler.

In some embodiments, the sample analyzer further comprises a second fluid dosing device, which is in communication with the first through-hole and is used to control a flow rate and/or a volume of the first reagent entering the reaction tank.

In some embodiments, the sample analyzer further comprises a control unit coupled to the first fluid dosing device and the second fluid dosing device for controlling a fluid discharging action of the first fluid dosing device and the second fluid dosing device such that the biological sample discharged by the sampler comes into contact with air first and then into contact with the first reagent.

In some embodiments, the sample analyzer further comprises a control unit coupled to the second fluid dosing device for controlling fluid discharging of the second fluid dosing device at a first flow rate and a second flow rate, the first flow rate being different from the second flow rate.

In some embodiments, the sample analyzer further comprises a moving assembly that clamps the sampler and can move the sampler.

In some embodiments, the wall is further provided with a second through-hole for injecting a second reagent, and the second through-hole is spaced apart from the first through-hole.

In some embodiments, the sample analyzer further comprises a third fluid dosing device, which is in communication with the second through-hole and is used to control the volume of the second reagent entering the reaction tank.

In some embodiments, the wall is further provided with an outflow hole, and a height of the outflow hole in the reaction tank is lower than a height of a tip of the sampler in the reaction tank.

In another aspect, there is further provided a sample analyzer comprising a reaction assembly described above and a detection assembly, wherein the detection assembly is connected to the reaction tank and is used for drawing fluid from the reaction tank and carrying out a test.

In yet another aspect, there is further provided a mixing method for mixing a biological sample and a reagent. The method includes moving a sampler with a biological sample into a reaction tank, dispensing a suspended part of the biological sample to a tip of the sampler such that the suspended part comes into contact with air, entering a first reagent into the reaction tank to form a swirling flow, and making the swirling flow contact with the tip of the sampler to mix with the suspended part of the biological sample.

In some embodiments, the mixing method further includes dispensing a flushing part of the biological sample into the swirling flow such that the swirling flow directly mixes in the flushing part.

In some embodiments, the sampler continuously dispenses the suspended pail and the flushing part.

In some embodiments, a position of the sampler after entering the reaction tank is misaligned with a direction in which the first reagent enters into the reaction tank.

In some embodiments, the flow rate of the first reagent entering the reaction tank comprises a first flow rate and a second flow rate, and the second flow rate is different from the first flow rate.

in some embodiments, the flow rate of the first reagent entering the reaction tank changes from the first flow rate to the second flow rate, and the second flow rate is greater than the first flow rate.

In some embodiments, the process of the first reagent entering the reaction tank comprises a first stage and a second stage, and the flow rate of the first stage is less than a flow rate of the second stage.

In some embodiments, the swirling flow makes contact with the tip of the sampler in the first stage.

In some embodiments, after the swirling flow comes into contact with the suspended part, the sampler moves in the reaction tank to cause the biological sample to be attached to an outer wall surface of the sampler to detach from the sampler

In some embodiments, a second reagent enters the reaction tank after the first reagent forms the swirling flow.

In some embodiments, the first reagent comprises at least a diluent and the second reagent comprises at least a hemolytic agent.

In some embodiments, the first reagent comprises at least a hemolytic agent and the second reagent comprises at least a dye.

### BRIEF DESCRIPTION OF THE DRAWINGS

In order to explain the technical solution of the present application more clearly, the drawings needed in the embodiments will be briefly introduced in the following. Obviously, the drawings in the following description are only some embodiments of the present application. For those skilled in the art, further drawings can be obtained as these drawings without inventive effort.

FIG. 1 is a schematic structure diagram of a sample analyzer provided by the present application.

FIG. 2 is a schematic structure diagram of another embodiment of a reaction tank of the sample analyzer shown in Fig. I.

FIG. 3 is a schematic structure diagram of the reaction tank shown in FIG. 2 taken along section line

FIG. 4 is a schematic structure diagram of yet another embodiment of a sampler and a reaction tank of the sample analyzer shown in FIG. 1.

FIG. 5 is a schematic structure diagram of still another embodiment of a sampler and a reaction tank of the sample analyzer shown in FIG. 1.

FIG. 6 is a white blood cell scatter diagram with a high red blood cell count obtained by a sample analyzer of the prior art.

FIG. 7 is a first white blood cell scatter diagram with a high red blood cell count obtained by the sample analyzer shown in FIG. 1.

FIG. 8 is a second white blood cell scatter diagram with a high red blood cell count obtained by the sample analyzer shown in FIG. 1.

### DETAILED DESCRIPTION OF EMBODIMENTS

Compared with the prior art, the present application has the following beneficial effects:

Due to the arrangement of the center line of the first through-hole misaligned with the sampler, the first reagent does not directly impact on the sampler when entering the reaction tank from the first through-hole, so that the resistance to the flow of the first reagent is small, and therefore the first reagent can smoothly form a swirling flow along an inner wall of the reaction tank, thereby better mixing with the biological sample. With a high mixing degree of the first reagent and the biological sample and a good reaction effect between the first reagent and the biological sample, the detection assembly can obtain a more accurate test result based on the fluid to be tested formed by the reaction between the first reagent and the biological sample, so that accuracy of the test result of the sample analyzer is high.

The technical solutions of the embodiments of the present application will be described below clearly and comprehensively in conjunction with the drawings of the embodiments of the present application. Clearly, the embodiments described are merely some embodiments of the present application and are not all the possible embodiments. Based on the embodiments given in the present application, all other embodiments that would be obtained by those of ordinary skill in the art without expending inventive effort shall all fall within the scope of protection of the present application.

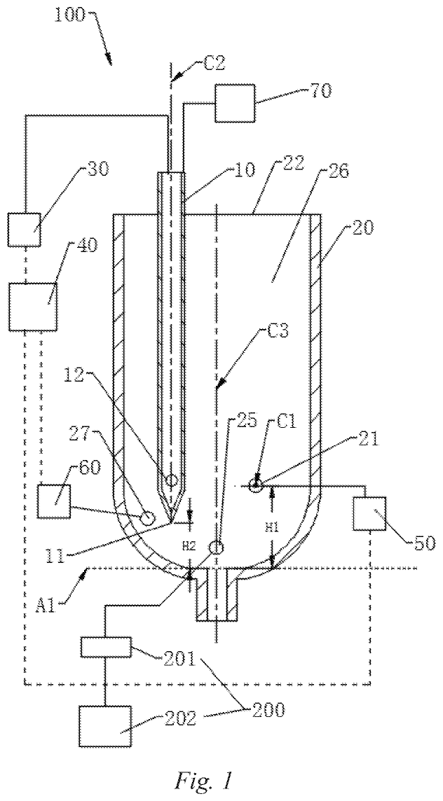

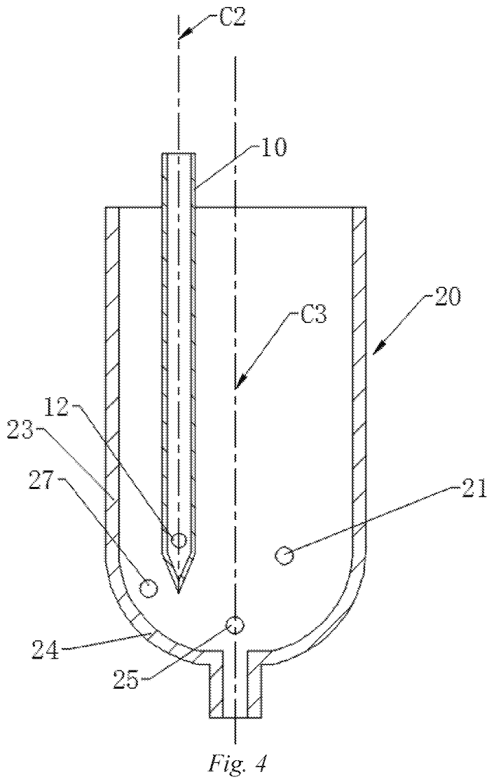

Referring to FIGS. 1 to 5, an embodiment of the present application provides a sample analyzer 100. The sample analyzer 100 can be used to analyze a biological sample, such as a blood sample and a urine sample.

The sample analyzer 100 comprises a reaction assembly and a detection assembly 200. The reaction assembly is used for processing the biological sample to form a fluid to be tested. The reaction assembly comprises a sampler 10 and a reaction tank 20, wherein the reaction tank 20 is used for forming and storing the fluid to be tested. The detection assembly 200 is connected to the reaction tank 20 for drawing and testing the fluid to be tested in the reaction tank 20.

The sampler 10 is used to collect a biological sample and inject the biological sample into the reaction tank 20. A wall of the reaction tank 20 is provided with a first through-hole 21, and the first through-hole 21 is used for injecting a first reagent. A center line C1 of the first through-hole 21 is arranged to be misaligned with the sampler 10 after the sampler 10 moves into the reaction tank 20.

In this embodiment, after the first reagent enters the reaction tank 20, it will swirl along an inner wall of the reaction tank 20 (the inner wall surface of the wall) to form a swirling flow. The sampler 10 dispenses the biological sample in the air. Due to a slow flow rate, the biological sample is slowly suspended at a tip 11 of the sampler 10, and this part of the biological sample is referred to as a suspended part of the biological sample (i.e., the biological sample suspended at the tip 11 of the sampler 10). The suspended part first comes into contact with the air. The fluid level of the swirling flow formed by the first reagent entering the reaction tank 20 continuously rises. After the swirling flow comes into contact with the suspended part, the swirling flow will drive the suspended part to flow, thus mixing the suspended part with the first reagent.

It can be understood that the biological sample may comprise only the suspended part or may also comprise a flushing part in addition. While the swirling flow formed by the first reagent continues rising, the sampler 10 continues to dispense the flushing part, in which case the swirling flow directly carries away the flushing part for mixing.

In short, dispensing the biological sample in the air and then the swirling flow formed by the first reagent carrying away and mixing with the biological sample enables a high mixing degree of the first reagent and the biological sample.

In this embodiment, due to the arrangement of the center line C1 of the first through-hole 21 misaligned with the sampler 10, the first reagent does not directly impact on the sampler 10 when entering the reaction tank 20 from the first through-hole 21, so that the resistance to the flow of the first reagent is small, and therefore the first reagent can smoothly form a swirling flow along the inner wall of the reaction tank 20, thereby better mixing with the biological sample. With a high mixing degree of the first reagent and the biological sample and a good reaction effect between the first reagent and the biological sample, the detection assembly 200 can obtain a more accurate test result based on the fluid to he tested formed by the reaction between the first reagent and the biological sample, so that accuracy of the test result of the sample analyzer 100 is high.

It can be understood that the first reagent entering the reaction tank 20 and the sampler 10 dispensing the biological sample can start one after the other or can alternatively start at the same time, as long as the sampler 10 can dispense the suspended part in the air such that the suspended part comes into contact with the air first before the first reagent comes into contact and mixes with the suspended part.

Alternatively, the sampler 10 may be a sampling needle. A nozzle 12 of the sampler 10 is used to suck in or expel the biological sample. The nozzle 12 of the sampler 10 can be arranged on a side wall of the sampler 10 to make it easier for the biological sample flowing out from the nozzle 12 to he suspended at the tip 11 of the sampler 10.

Alternatively, the reaction tank 20 is provided with an opening 22, and the sampler 10 moves into the reaction tank 20 through the opening 22. The opening 22 is arranged atop the reaction tank 20. A reaction chamber 26 in communication with the opening 22 is formed in the reaction tank 20, and the reaction chamber 26 is used for providing a space for mixing and reaction of the biological sample and the first reagent.

Alternatively, the height H2 of the tip 11 of the sampler 10 in the reaction tank 20 is less than or equal to the height H1 of the centerline C1 of the first through-hole 21 in the reaction tank 20. The fluid level of the first reagent entering the reaction tank 20 will eventually become higher than the height HI of the first through-hole 21 in the reaction tank 20, so that the first reagent entering the reaction tank 20 later can continuously drive the first reagent entering the reaction tank 20 before, and the swirling flow formed by the first reagent can swirl continuously. When the height of the tip 11 of the sampler 10 in the reaction tank 20 is less than or equal to the height of the first through-hole 21 in the reaction tank 20, the tip 11 of the sampler 10 is closer to a central region of the swirling flow, which can better mix in the biological sample and further improve the mixing degree of the first reagent and the biological sample. Those skilled in the art can understand that if the swirling flow formed by the first reagent can make contact with the tip 11 of the sampler 10, the height of the tip 11 of the sampler 10 in the reaction tank 20 can alternatively be greater than the height of the center line C1 of the first through-hole 21.

It can be understood that “the height in the reaction tank 20” refers to a vertical distance relative to a height reference plane A1. The height reference plane A1 is the horizontal plane in which the lowest point of the inner wall of the reaction tank 20 is located.

Alternatively, the center line C1 of the first through-hole 21 and a center line C3 of the reaction tank 20 are arranged in different planes. In this case, after the first reagent enters the reaction tank 20 from the first through-hole 21, the first reagent can impact on the inner wall of the reaction tank 20 at a high speed, thereby directly forming a swirling flow. In addition, since the center line C1 of the first through-hole 21 and the center line C3 of the reaction tank 20 are arranged in different planes, and the center line C1 of the first through-hole 21 is misaligned with the center line C3 of the reaction tank 20, the first reagent will not perpendicularly impact on the inner wall of the reaction tank 20, so that energy waste can be effectively avoided, thus being more favorable to the formation of the swirling flow.

Referring to FIG. 1, as an alternative embodiment, the wall comprises a first part 23 with two open ends and a second part 24 connected to one of the open ends. The first part 23 is columnar and the second part 24 is cambered. The second part 24 comprises first and second ends disposed opposite each other, the first end being connected to the first part 23 and the second end being disposed away from the first part 23. The second part 24 tapers in a direction from the first end to the second end.

In this embodiment, the first part 23 is columnar and the second part 24 is cambered. The cambered design of the second part 24 facilitates the formation of the swirling flow by the first reagent after entering the reaction tank 20.

Alternatively, the first through-hole 21 is arranged close to a junction of the first part 23 and the second part 24. In this case, the first reagent will impact on the second part 24 after entering the reaction tank 20, and the second part 24 will impose aforce in an upward direction on the first reagent, so the first reagent can form a three-dimensional swirling flow, and the flow direction of the swirling flow forms an comprised angle with both horizontal and vertical planes. The three-dimensional swirling flow is favorable to improvement of the mixing degree of the first reagent and the biological sample.

Alternatively, the first reagent comprises at least a hemolytic agent, and mixing and hemolysis reaction occur simultaneously at the instant of sample contact, which is favorable to obtaining a good hemolysis effect. Alternatively, the first reagent may further comprise a dye, including a fluorescent dye, so that the biological sample in the fluid to be tested is dyed to generate a fluorescence signal when tested.

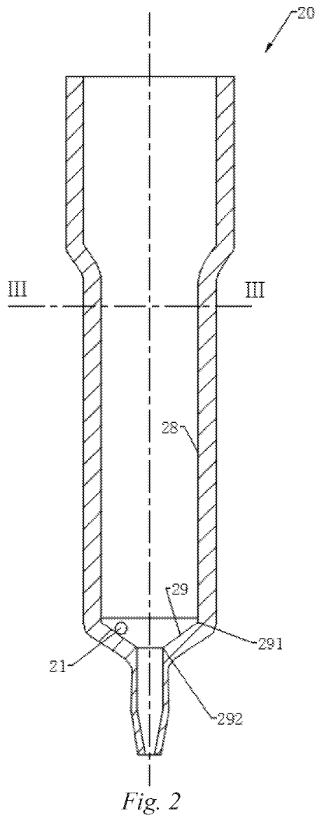

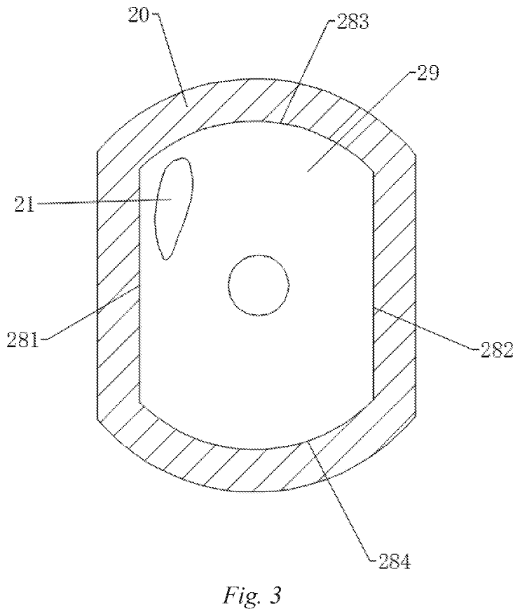

Referring to FIGS. 2 and 3 together, as another alternative embodiment, an inner side of the wall comprises a first wall surface 28 and a second wall surface 29 connected to the first wall surface 28 The first wall surface 28 comprises a first flat surface 281, a second flat surface 282, a first cambered surface 283 and a second cambered surface 284. The first flat surface 281 and the second flat surface 282 are arranged opposite each other. The first cambered surface 283 and the second cambered surface 284 are arranged opposite each other and connected between the first flat surface 281 and the second flat surface 282. The second wall surface 29 comprises a first end 291 connected to the first wall surface 28 and a second end 292 away from the first wall surface 28. The second wall surface 29 tapers in a direction from the first end 291 to the second end 292.

Alternatively, the first through-hole 21 extends through the second wall surface 29 or a junction of the first wall surface 28 and the second wall surface 29.

In this embodiment, since the second wall surface 29 tapers in a direction from the first end 291 to the second end 292, and the first through-hole 21 extends through the second wall surface 29 or a junction of the first wall surface 28 and the second wall surface 29, the first reagent impacts on the inner side of the wall and forms a three-dimensional swirling flow under the guidance of the inner side of the wall when the first reagent enters the reaction tank from the first through-hole 21. The first reagent in a swirling state can mix well with the biological sample, achieving a high mixing degree of the first reagent and the biological sample and a good reaction effect of the first reagent and the biological sample.

Alternatively, the first reagent comprises at least a diluent and an optional hemolytic agent, so that cells in the biological sample can be well diluted and dispersed.

Referring to FIG. 1, as an alternative embodiment, the reaction assembly further comprises a first fluid dosing device 30. The first fluid dosing device 30 is in communication with the sampler 10 and is used to control the volume of the biological sample discharged by the sampler 10. The first fluid dosing device 30 can control the volume of the biological sample discharged by the sampler 10, thereby being beneficial to the control of the ratio of the biological sample to the first reagent, enabling the reaction assembly to produce the fluid to be tested as required, and ensuring the accuracy of the test result of the detection assembly 200.

The first fluid dosing device 30 may be an injector capable of quantitative and intermittent dosing of the biological sample, thereby enabling the sampler 10 to dispense an exact amount of the biological sample into a plurality of different reaction tanks 20. Moreover, the injector can also control the flow rate of the biological sample discharged by the sampler 10, thereby being beneficial to improvement of the mixing degree of the first reagent and the biological sample.

Referring to FIG. 1, as an alternative embodiment, the reaction assembly further comprises a second fluid dosing device 50, and the second fluid dosing device 50 is in communication with the first through-hole 21 and is used to control the volume and/or flow rate of the first reagent entering the reaction tank 20. The second fluid dosing device 50 can control the volume and/or flow rate of the first reagent entering the reaction tank 20, thereby being beneficial to the control of the ratio of the biological sample to the first reagent, enabling the reaction assembly to produce the fluid to be tested as required, and ensuring the accuracy of the test result of the detection assembly 200.

The second fluid dosing device 50 may be an injector, which can control the volume and/or flow rate of the first reagent discharged by the sampler 10, thereby being beneficial to improvement of the mixing degree of the first reagent and the biological sample.

Alternatively, a control unit 40 is coupled to the first fluid dosing device 30 and the second fluid dosing device 50 for controlling a fluid discharging action of the first fluid dosing device 30 and the second fluid dosing device 50 such that the biological sample (e.g., the suspended part) discharged by the sampler 10 comes into contact with air first and then into contact with the first reagent.

Alternatively, the reaction assembly further comprises a control unit 40, and the control unit 40 is coupled to the second fluid dosing device 50 for controlling fluid discharging of the second fluid dosing device 50 at a first flow rate and a second flow rate, the first flow rate being different from the second flow rate. The control of the second fluid dosing device 50 by the control unit 40 is beneficial to improvement of the mixing and reaction speed of the biological sample and the first reagent.

It is to be understood that the first flow rate may be greater than or less than the second flow rate. The second fluid dosing device 50 may discharge fluid at the first flow rate first and then at the second flow rate, or may alternatively discharge fluid art the second flow rate first and then at the first flow rate. For example, the second fluid dosing device 50 discharges the fluid at the first flow rate first and then discharges the fluid at the second flow rate, and the first flow rate is less than the second flow rate, so that the first reagent can better mix with the biological sample.

In other embodiments, the first reagent can also enter the reaction tank 20 at a constant rate, in which case the first flow rate is equal to the second flow rate.

In other embodiments, the process of the first reagent entering the reaction tank 20 comprises a first stage and a second stage, wherein the first stage precedes the second stage. The flow rate of the first stage is less than the flow rate of the second stage. A first time point when the fluid entering process is switched from the first stage to the second stage is after a second time point when the first reagent comes into contact with the biological sample, so that the first reagent can better mix with the biological sample, and the mixing degree of the first reagent and the biological sample is higher.

In other embodiments, the first time point may alternatively precede the second time point.

In other embodiments, the flow rate of the first stage may alternatively be greater than the flow rate of the second stage.

It can be understood that in the first stage or the second stage, the flow rate of the first reagent into the reaction tank 20 may be constant (in which case the first flow rate and the second flow rate are in the first stage and the second stage, respectively) or may be variable (in which case the first flow rate and the second flow rate may be in the same stage or may be in different stages).

In other embodiments, there is an acceleration in the flow rate of the first reagent entering the reaction tank 20. The acceleration may be a constant value, so that the flow rate of the first reagent entering the reaction tank 20 presents a linear acceleration trend. The acceleration may alternatively be a variable value, so that the flow rate of the first reagent entering the reaction tank 20 presents a curved acceleration trend. In this case, the first flow rate and the second flow rate are two of the varying flow rates of the first reagent entering the reaction tank 20.

Referring to FIG. 1, as an alternative embodiment, the reaction assembly further comprises a moving assembly 70, and the moving assembly 70 clamps the sampler 10 and can move the sampler 10. The moving assembly 70 can clamp and move the sampler 10, for example, first moving the sampler 10 to a first position so that the sampler 10 collects the biological sample; then moving the sampler 10 to a second position to cause the sampler 10 to dispense the biological sample; and next, swinging the sampler 10 several times while the sampler 10 moves into the reaction tank 20 and remains in contact with the first reagent, so that the biological sample attached to the outer wall surface of the sampler 10 is carried away by the first reagent and detached from the sampler 10.

Referring to FIGS. 1, 4 and 5 together, as an alternative embodiment, the wall is further provided with a second through-hole 27. The second through-hole 27 is used for injecting a second reagent, and the second through-hole 27 is spaced apart from the first through-hole 21. The second reagent is different from the first reagent.

Alternatively, the aforementioned swinging motion of the sampler 10 in the reaction tank 20 may alternatively be performed during the addition of the second reagent, and the biological sample attached to the outer wall surface of the sampler 10 is carried away by the first reagent and the second reagent.

Alternatively, the reaction assembly further comprises a third fluid dosing device 60, and the third fluid dosing device 60 is in communication with the second through-hole 27 and is used to control the volume of the second reagent entering the reaction tank 20. The third fluid dosing device 60 can control the volume of the second reagent entering the reaction tank 20, thereby being beneficial to the control of the ratio of the biological sample to the first reagent and the second reagent, enabling the reaction assembly to produce the fluid to be tested as required, and ensuring the accuracy of the test result of the detection assembly 200.

Of course, in other embodiments, the wall may not be provided with the second through-hole 27, and other reagents may also enter the reaction tank 20 from the first through-hole 21.

Alternatively, in the case where the dye and the hemolytic agent need to be added at different times, due to the small amount of the dye used, generally 20 μl, it is more appropriate for the dye as the second reagent to be added through the second through-hole 27.

Alternatively, in the case where the diluent and the hemolytic agent need to be added at different times, because the volume of the hemolytic agent is less than that of the diluent, it is more appropriate for the hemolytic agent as the second reagent to be added through the second through-hole 27.

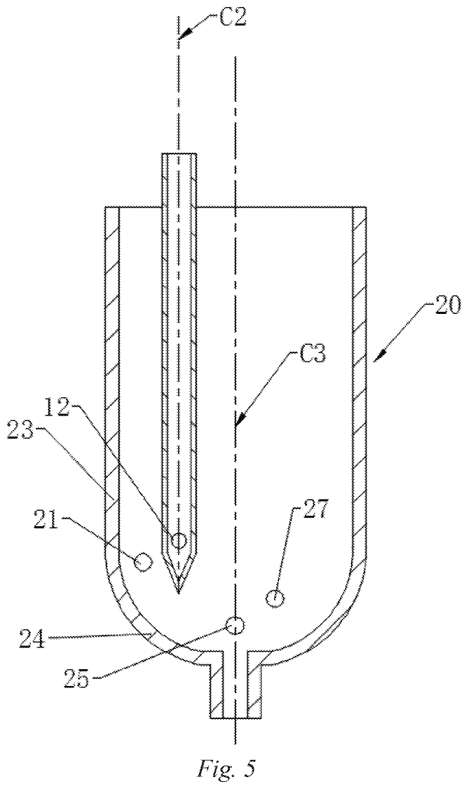

Alternatively, the center line C2 of the sampler 10 and the center line C3 of the reaction chamber 26 are located in a first plane. As shown in Fig, 4, in the first plane, the first through-hole 21 and the sampler 10 are located on the same side of the center line C3 of the reaction chamber 26. Alternatively, as shown in FIG. 5, in the first plane, the first through-hole and the sampler 10 are located on different sides of the center line C3 of the reaction chamber 26, and the first through-hole is arranged to be misaligned with the sampler 10.

Referring to FIGS. 1, 4 and 5 together, as an alternative embodiment, the wall is further provided with an outflow hole 25, and the detection assembly 200 is connected to the outflow hole 25. The height of the outflow hole 25 in the reaction tank 20 is lower than the height of the tip 11 of the sampler 10 in the reaction tank 20. The position of the outflow hole 25 is arranged in favor of the test assembly 200 drawing the fluid to be tested formed in the reaction tank 20.

In other embodiments, the height of the outflow hole 25 in the reaction tank 20 may alternatively be greater than the height of the tip 11 of the sampler 10 in the reaction tank 20, so long as the detection assembly 200 can draw sufficient fluid to be tested from the outflow hole 25.

Referring to FIGS. 1, 6 and 7 together, as an alternative embodiment, the detection assembly 200 comprises an optical detection assembly 201 and a switching member 202, and the switching member 202 is connected between the optical detection assembly 201 and the reaction tank 20. The optical detection assembly 201 is used for testing the fluid to be tested by an optical detection method.

For example, the biological sample is blood, the first reagent is a hemolytic agent, the second reagent is a dye, and the fluid to be tested is used for performing three function tests, namely, the leukocyte (white blood cell, WBC) count, nucleated red blood cell (NRBC) classification, and basophil (BASO) classification.

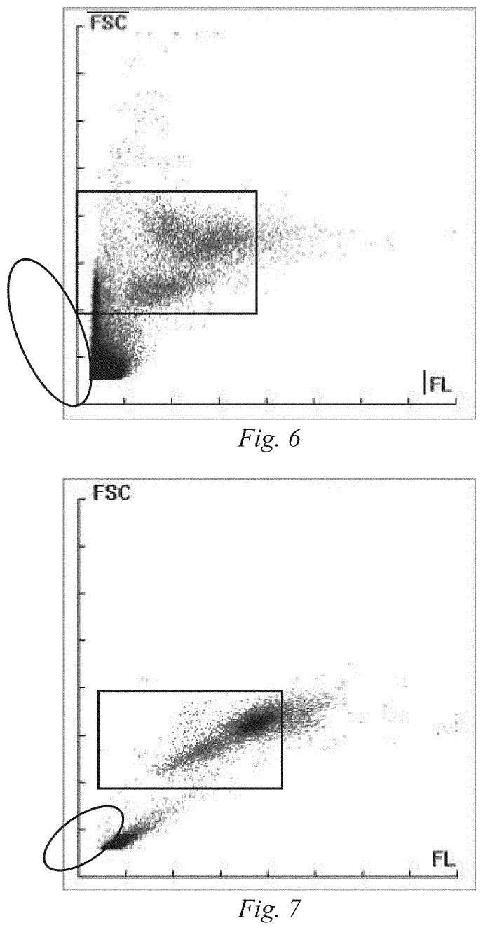

FIGS. 6 and 7 are white blood cell scatter diagrams of blood samples tested by a Mindray BC6800 hematology analyzer. Each dot in the diagram represents a cell or particle. The vertical axis FSC represents the forward scatter intensity of the cell or particle, while the horizontal axis FL represents the fluorescence intensity of the cell or particle. The region in the rectangular black frame is the distribution of white blood cell particles, and dots in this region are used for counting white blood cells and classifying nucleated red blood cells and basophils. The region in the ellipse black frame is the distribution of the ghost generated after hemolysis of red blood cells and blood platelet (PLT) particles, and dots in this region are not involved in the counting and classification of the white blood cells.

A white blood cell scatter diagram with a high red blood cell count obtained by a sample analyzer of the prior art is shown in FIG. 6, in which a large amount of ghost particles appear in the ghost region of the ellipse black frame and are not clearly distinguished from the white blood cell particles in the rectangular black frame, thus interfering with the counting and classification of the white blood cells; and moreover, the boundary of various subpopulations in the white blood cell particle region is also unclear due to improper hemolysis, which leads to errors in the classification of nucleated red blood cells and basophils.

The sample analyzer 100 of this embodiment greatly improves the reaction effect for samples with the same high red blood cell count, as shown in FIG. 7, in which particles in the ghost region in the ellipse black frame are greatly reduced and are far away from the white blood cell particles in the rectangular black frame, thus not interfering with the white blood cells. Moreover, the clear aggregation formed in the white blood cell particle region is beneficial to the counting and classification of the white blood cell particles.

Referring to FIGS. 1 to 5, an embodiment of the present application also provides a mixing method for mixing a biological sample and a reagent. The biological sample reacts with the reagent when mixed so as to form a fluid to be tested. The mixing method can be carried out in the above reaction assembly.

The mixing method includes the following steps:

S01: A sampler 10 with a biological sample moves into a reaction tank 20. The sampler 10 can draw the biological sample from a sample container.

S02: The sampler 10 dispenses a suspended part of the biological sample to a tip 11 of the sampler 10 such that the suspended part comes into contact with air. In this step, the suspended part can be slowly suspended at the tip 11 of the sampler 10 by controlling the discharging rate of the sampler 10.

S03: A first reagent enters the reaction tank 20 to form a swirling flow. In this step, by controlling the direction, flow rate and volume of the first reagent entering the reaction tank 20, the swirling flow can be formed by the first reagent.

S04: The swirling flow makes contact with the tip 11 of the sampler 10 to mix the suspended part in. In this step, when the fluid level of the swirling flow formed by the first reagent rises into contact with the tip 11 of the sampler 10, the first reagent makes contact and mixes with the suspended part. Once the swirling flow starts mixing the suspended part in, the first reagent starts to react with the suspended part of the biological sample.

In this embodiment, the mixing method uses a mode of dispensing the biological sample in the air and then the swirling flow formed by the first reagent carrying away and mixing with the biological sample, so that with a high mixing degree of the first reagent and the biological sample and a good reaction effect between the first reagent and the biological sample, the detection assembly 200 can obtain a more accurate test result based on the fluid to be tested formed by the reaction between the first reagent and the biological sample, thus enabling high accuracy of the test result of the sample analyzer 100.

It can be understood that the white blood cell scatter diagram as shown in FIG. 7 can be obtained in the test assembly 200 by using the mixing method described to process the fluid to be tested (for performing three function tests, i.e. the leukocyte (white blood cell, WBC) count, nucleated red blood cell (NRBC) classification, and basophil (BASO) classification).

It can he understood that the starting time for the sampler 10 to dispense the suspended part in step S02 and the starting time for the first reagent to enter the reaction tank 20 in step S03 are not in a particular order, as long as the requirement for the suspended part to come into contact with the air before the first reagent can be satisfied.

In one embodiment, the biological sample comprises only the suspended part, in another embodiment, the biological sample further comprises a flushing part.

Alternatively, the mixing method further comprises: the sampler 10 dispensing a flushing part of the biological sample to the swirling flow such that the swirling flow directly mixes the flushing part in. In other words, the sampler 10 dispenses the flushing part in the first reagent, the flushing part after flowing out of the sampler 10 is directly carried away by the first reagent in a swirling state for mixing, and the flushing part and the first reagent react with each other when mixed.

In this embodiment, the sampler 10 first dispenses the suspended part of the biological sample in the air and then dispenses the flushing part of the biological sample in the swirling flow (i.e., the first reagent). The first reagent continuously entering the reaction tank 20 maintains in a swirling flow state, and the suspended part and the flushing part are sequentially mixed by mixing in the swirling flow state, and therefore with a high mixing degree of the first reagent and the biological sample and a good reaction effect therebetween, the detection assembly 200 can obtain a more accurate test result based on the fluid to be tested formed by the reaction between the first reagent and the biological sample, thus enabling high accuracy of the test result of the sample analyzer 100.

Alternatively, the sampler 10 continuously dispenses the suspended part and the flushing part. In this embodiment, the flow rate of the biological sample dispensed by the sampler 10 can be controlled such that the flushing part is discharged from the sampler 10 immediately after the suspended part, thereby being beneficial to improving the mixing speed of the mixing method.

Alternatively, the position of the sampler 10 after entering the reaction tank 20 is misaligned with the direction in which the first reagent enters the reaction tank 20. In this case, the first reagent does not directly impact on the sampler 10 when entering the reaction tank 20, so that the resistance to the flow of the first reagent is small, and therefore the first reagent can smoothly form a swirling flow along the inner wall of the reaction tank 20, thereby better mixing with the biological sample and improving the mixing degree of the first reagent and the biological sample.

As an alternative embodiment, the flow rate of the first reagent entering the reaction tank 20 comprises a first flow rate and a second flow rate, and the second flow rate is different from the first flow rate. The change of the flow rate of the first reagent entering the reaction tank is beneficial to improvement of the mixing and reaction speed of the biological sample and the first reagent. It is to be understood that the first flow rate may be greater than or less than the second flow rate.

Alternatively, the flow rate of the first reagent entering the reaction tank 20 changes from the first flow rate to the second flow rate, and the second flow rate is greater than the first flow rate. The flow rate of the first reagent entering the reaction tank 20 presents an acceleration trend, which is favorable for the first reagent to better mix with the biological sample.

In other embodiments, the first reagent can also enter the reaction tank 20 at a constant rate, in which case the first flow rate is equal to the second flow rate.

As an alternative embodiment, the process of the first reagent entering the reaction tank comprises a first stage and a second stage, and the flow rate of the first stage is less than the flow rate of the second stage. The first stage precedes the second stage. A first time point when the fluid entering process is switched from the first stage to the second stage is after a second time point when the first reagent comes into contact with the biological sample, so that the first reagent can better mix with the biological sample, and the mixing degree of the first reagent and the biological sample is higher.

In other embodiments, the first time point may alternatively precede the second time point if the requirements for blending and reaction effect are not high.

In other embodiments, the flow rate of the first stage may alternatively be greater than the flow rate of the second stage.

It can be understood that in the first stage or the second stage, the flow rate of the first reagent into the reaction tank 20 may be constant (in which case the first flow rate and the second flow rate are in the first stage and the second stage, respectively) or may be variable (in which case the first flow rate and the second flow rate may be in the same stage or may be in different stages).

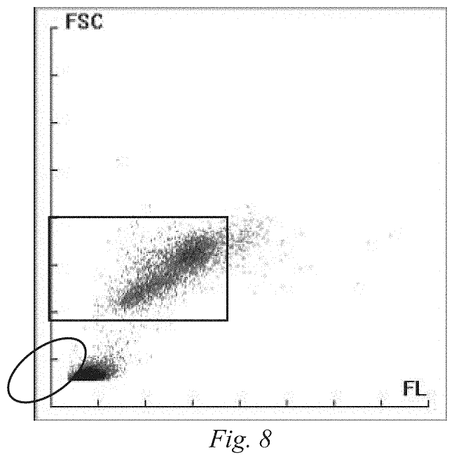

As shown in FIGS. 7 and 8, FIGS. 7 and 8 are both white blood cell scatter diagrams obtained by testing a high red blood cell count sample formed by the mixing method. The first reagent of the mixing method used by the sample corresponding to FIG. 7 enter the reaction tank 20 at an increasing rate, and the first reagent of the mixing method used by the sample corresponding to FIG. 8 enters the reaction tank 20 at a constant rate. Compared with the prior art, the reaction effect of the samples corresponding to FIGS. 7 and 8 has been greatly improved. In FIG. 8 (corresponding to the approach in which the first reagent enters the reaction tank at a constant rate), although the ghost region in the ellipse black frame and the white blood cell particle region in the rectangular black frame can be separated, the particle aggregation performance of the White blood cell particle region in the rectangular black frame are not as good as that shown in FIG. 7 (corresponding to the approach in which the first reagent enters the reaction tank at an increasing rate), which may cause the accuracy for identification of basophils to be affected. Therefore, the acceleration of the first reagent entering the reaction tank 20 can further improve the mixing degree of the first reagent and the biological sample, so that the reaction effect between the first reagent and the biological sample is better.

Alternatively, the swirling flow makes contact with the tip 11 of the sampler in the first stage. The swirling flow firstly makes contact and mixes with the biological sample at a relatively low flow rate, and then continuously mixes with the biological sample at a relatively high flow rate, which is beneficial to improvement of the mixing and reaction of the first reagent and the biological sample.

As an alternative embodiment, there is an acceleration in the flow rate of the first reagent entering the reaction tank 20. The acceleration may be a constant value, so that the flow rate of the first reagent entering the reaction tank 20 presents a linear acceleration trend. The acceleration may alternatively be a variable value, so that the flow rate of the first reagent entering the reaction tank 20 presents a curved acceleration trend. In this case, the first flow rate and the second flow rate are two of the varying flow rates of the first reagent entering the reaction tank 20.

As an alternative embodiment, after the swirling flow comes into contact with the suspended part, the sampler 10 moves (e.g., swings several times) in the reaction tank 20 to cause the biological sample attached to the outer wall surface of the sampler 10 to detach from the sampler 10. In this case, the swinging motion of the sampler 10 in the reaction tank 20 can not only stir the fluid in the reaction tank 20, so that the mixing degree of the biological sample and the first reagent is higher, but also enable the entire biological sample that is preset to be involved in the reaction to participate in the mixing and reaction, thereby being beneficial to the control of the ratio of the biological sample to the first reagent, so as to obtain the fluid to be tested as required, which ensures the accuracy of results of subsequent tests.

Alternatively, the mixing method further comprises: introducing a small amount of bubbles at the bottom of the reaction tank 20 to mix the first reagent and the biological sample. This step can start after the first reagent entirely enters the reaction tank 20. This step may be carried out simultaneously with the step of moving the sampler 10 in the reaction tank 20 or may be carried out separately.

It should be noted that the amount of bubbles introduced in this step is much less than the amount of bubbles in the method of “mixing by means of introducing bubbles” of the prior art. In this step, the small amount of bubbles is beneficial to the mixing and reaction of the first reagent and the biological sample, which further improves the reaction effect to obtain a scatter diagram with better discrimination degree; and moreover, the small amount of bubbles disappear quickly, thus avoiding lowering the test speed of the sample analyzer.

As an alternative embodiment, a second reagent enters the reaction tank 20 after the first reagent forms the swirling flow in this embodiment, the volume of the second reagent is less than the volume of the first reagent. When the second reagent enters the reaction tank 20 after the first reagent enters the reaction tank 20 first and forms a swirling flow, the second reagent can be directly brought into the swirling flow, so that the second reagent can mix and react well with the first reagent and the biological sample. For example, the first reagent is a hemolytic agent and the second reagent is a dye.

Of course, in other embodiments, the second reagent may enter the reaction tank 20 first, in which case the second reagent may be suspended on the inner wall of the reaction tank 20 or located at the bottom of the reaction tank 20 as long as it does not make contact with the biological sample. The first reagent directly mixes with the second reagent after entering the reaction tank 20.

Alternatively, the position where the first reagent enters the reaction tank 20 and the position where the second reagent enters the reaction tank 20 are misaligned with each other. In this case, the control of the time when the first reagent enters the reaction tank 20 and the time when the second reagent enters the reaction tank 20 is more flexible, and the first reagent can also cooperate with the second reagent to better form the swirling flow.

Of course, in other embodiments, the position where the first reagent enters the reaction tank 20 may alternatively be the same as the position where the second reagent enters the reaction tank 20.

Alternatively, the first reagent comprises at least a diluent and the second reagent comprises at least a hemolytic agent. In this case, the fluid to be tested can be used for a test for the hemoglobin (HGB) count of the biological sample.

Alternatively, the first reagent comprises at least a hemolytic agent and the second reagent comprises at least a dye. In this case, the fluid to be tested can be used in tests for the leukocyte (white blood cell, WBC) count, nucleated red blood cell (NRBC) classification and basophil (BASO) classification, or white blood cell (WBC) classification, or reticulocyte (Ret) count.

Alternatively, the first reagent is a mixed solution of a hemolytic agent and a dye, and the second reagent is not provided or the second reagent is provided as a diluent. In this case, the fluid to be tested can be used in tests for the leukocyte (white blood cell, WBC) count, nucleated red blood cell (NRBC) classification and basophil (BASO) classification, or white blood cell (WBC) classification, or reticulocyte (Ret) count.

The embodiments of the present application have been described in detail above, and specific examples are used herein to explain the principles and implementation of the present application. The above description of the embodiments is only used to facilitate understanding of the method of the present application and the core concept thereof. Moreover, for those skilled in the art, there can be modifications in the specific implementation and application scope based on the concept of the present application. To sum up, the content of this specification should not be construed as limiting the present application.

What is claimed is:

1. A sample analyzer, comprising:
a reaction assembly; and
a detection assembly,
wherein the reaction assembly comprises a sampler and a reaction tank, the sampler is used for collecting a biological sample and injecting the biological sample into the reaction tank, a wall of the reaction tank is provided with a first through-hole used for injecting a first reagent, and a center line of the first through-hole is arranged to be misaligned with the sampler after the sampler moves into the reaction tank,
wherein the detection assembly is connected to the reaction tank and is used for drawing fluid from the reaction tank for test.

2. The sample analyzer of claim 1, wherein the center line of the first through-hole and a center line of the reaction tank are arranged in different planes.

3. The sample analyzer of claim 1, wherein the wall comprises a first part with two open ends and a second part connected to one of the open ends, the first part is columnar and the second part is cambered.

4. The sample analyzer of claim 3, wherein the first through-hole is arranged at a junction of the first part and the second part.

5. The sample analyzer of claim 1, wherein an inner side of the wall comprises a first wail surface and a second wall surface connected to the first wall surface; the first wall surface comprises a first flat surface, a second fiat surface, a first cambered surface and a second cambered surface; the first flat surface and the second fiat surface are arranged opposite each other; the first cambered surface and the second cambered surface are arranged opposite each other and connected between the first flat surface and the second flat surface; the second wall surface comprises a first end connected to the first wall surface and a second end away from the first wall surface;
and the second wall surface tapers in a direction from the first end to the second end.

6. The sample analyzer of claim 5, wherein the first through-hole extends through the second wall surface or a junction of the first wall surface and the second wall surface.

7. The sample analyzer of claim 1, further comprising a first fluid dosing device, which is in communication with the sampler and is used to control a volume of the biological sample discharged by the sampler.

8. The sample analyzer of claim 7, further comprising a second fluid dosing device, which is in communication with the first through-hole and is used to control a flow rate and/or a volume of the first reagent entering the reaction tank.

9. The sample analyzer of claim 8, further comprising a control unit coupled to the first fluid dosing device and the second fluid dosing device for controlling a fluid discharging action of the first fluid dosing device and the second fluid dosing device such that the biological sample discharged by the sampler comes into contact with air first and then into contact with the first reagent.

10. The sample analyzer of claim 1, wherein the wall is further provided with a second through-hole for injecting a second reagent, and the second through-hole is spaced apart from the first through-hole.

11. The sample analyzer of claim 10, further comprising a third fluid dosing device, which is in communication with the second through-hole and is used to control the volume of the second reagent entering the reaction tank.

12. The sample analyzer of claim 1, wherein the wall is further provided with an outflow hole, and a height of the outflow hole in the reaction tank is lower than a height of a tip of the sampler in the reaction tank.

13. The sample analyzer of claim 1, wherein the reaction tank is provided with an opening, and the sampler extends into the reaction tank through the opening.

14. A mixing method for mixing a biological sample and a reagent comprising:
moving a sampler with a biological sample into a reaction tank;
dispensing a suspended part of the biological sample to a tip of the sampler such that the suspended part comes into contact with air;
entering a first reagent into the reaction tank to form a swirling flow; and
making the swirling flow contact with the tip of the sampler to mix with the suspended part of the biological sample.

15. The mixing method of claim 14, further comprising: dispensing a flushing part of the biological sample into the swirling flow such that the swirling flow directly mixes in the flushing part.

16. The mixing method of claim 14, further comprising: continuously dispensing the suspended part and the flushing part.

17. The mixing method of claim 16, wherein a position of the sampler after entering the reaction tank is misaligned with a direction in which the first reagent enters into the reaction tank.

18. The mixing method of claim 14, wherein the process of entering the first reagent into the reaction tank comprises a first stage and a second stage, and a flow rate of the first stage is less than a flow rate of the second stage.

19. The mixing method of claim 18, wherein the swirling flow makes contact with the tip of the sampler in the first stage.

20. The mixing method of claim 14, wherein after the swirling flow comes into contact with the suspended part, the sampler moves in the reaction tank to cause the biological sample to be attached to an outer wall surface of the sampler to detach from the sampler.

21. The mixing method of claims 14, further comprising entering a second reagent into the reaction tank after the first reagent forms the swirling flow

22. The mixing method of claim 21, wherein the first reagent comprises at least a diluent and the second reagent comprises at least a hemolytic agent; or
the first reagent comprises at least a hemolytic agent and the second reagent comprises at least a dye.
